(19) United States
(12) Patent Application Publication
(10) Pub. No.: US 2020/0210600 A1
(43) Pub. Date: Jul. 2, 2020

(54) DATA CENTER SECURE DEBUG UNLOCK

(71) Applicant: Advanced Micro Devices, Inc., Santa Clara, CA (US)

(72) Inventors: Tan Peng, San Jose, CA (US); Dong Zhu, Austin, TX (US)

(21) Appl. No.: 16/359,264

(22) Filed: Mar. 20, 2019

Related U.S. Application Data
(60) Provisional application No. 62/785,847, filed on Dec. 28, 2018.

(51) Int. Cl. G06F 21/62; G06F 11/36; H04L 9/30

(52) U.S. Cl. CPC G06F 21/62; H04L 9/30; G06F 11/36

(57) ABSTRACT

Systems, apparatuses, and methods for performing debug operations in a secure data center are disclosed. A system includes a computing module coupled to a debug target that includes a processing unit. Prior to being installed in a secure data center, the computing module is preloaded with a signed unlock payload and the debug target is preloaded with a public key of an authentication server. In response to a request to perform debug operations on the debug target in the secure data center, the computing module retrieves and conveys the preloaded signed unlock payload to the debug target. In response to the debug target validating the unlock request with a previously obtained public key of the authentication server, the debug target enters secure debug mode, unlocks the at least one processing unit for debug operations with an unlock vector from the validated unlock payload, and performs debug operations on the processing unit.

### PRIORITY INFORMATION

This application claims benefit of priority of U.S. Provisional Application Ser. No. 62/785,847 titled “Data Center Secure Debug Unlock” filed Dec. 28, 2018, whose inventors were Tan Peng and Dong Zhu, which is hereby incorporated by reference in its entirety as though fully and completely set forth herein.

### BACKGROUND

### Description of the Related Art

For certain organizations, a data center is not allowed to have connections to the outside world. This can be due to security reasons. For example, a financial institution, a government agency, or other organizations with sensitive information and/or applications might not want to allow any connections to external entities. However, if there is a problem, bug, or malfunction with a processor inside a secure data center, there is limited ability to debug or troubleshoot the issue in a remote/electronic manner since connections to outside of the data center are forbidden. Instead, a problematic server blade or rack platform is typically physically swapped out and replaced with a new server blade or rack platform. The stored data is then transferred to the new platform before the problematic platform is destroyed inside the data center. This approach of replacing the entire platform carries a high cost burden.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a system for preloading authorization payloads and keys to support future debug operations.

FIG. 2 is a block diagram of one implementation of a debug target.

FIG. 3 is a block diagram of one implementation of a system for performing debug operations within a secure data center.

FIG. 4 is a diagram of one implementation of a pre-request sequence for key and certificate generation prior to deployment in a secure data center.

FIG. 5 is a diagram of one implementation of a pre-request sequence performed prior to deployment in a secure data center.

FIG. 6 is a diagram of one implementation of a sequence for actual use of a preloaded secure debug unlock authorization payload inside a secure data center.

FIG. 7 is a generalized flow diagram illustrating one implementation of a method for implementing a prefetch operation of a secure data center debug mode dataset for future debug operations.

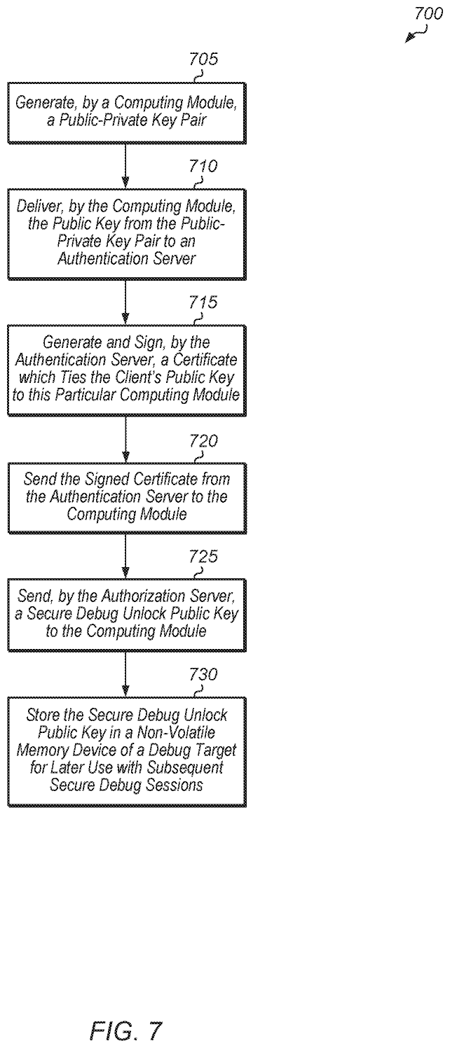

FIG. 8 is a generalized flow diagram illustrating one implementation of a method for performing a pre-request sequence for populating a secure data center database.

FIG. 9 is a generalized flow diagram illustrating one implementation of a method for performing debug operations in secure data center debug mode.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for performing debug operations in a secure data center are disclosed herein. In one implementation, a system includes a debug target with at least one processing unit, and the system includes a computing module coupled to the debug target. The computing module is preloaded with a signed unlock payload for unlocking the at least one processing unit on the debug target. Also, the debug target is preloaded with a public key of an authentication server. The preloading of the signed unlock payload on the computing module and the public key on the debug target is performed prior to the computing module and the debug target being installed inside of a secure data center.

In one implementation, in response to a request to perform debug operations on the debug target inside the secure data center, the computing module retrieves the preloaded signed unlock payload. Then, the computing module conveys the signed unlock payload to the debug target. The debug target enters into secure data center mode in response to receiving the signed unlock payload. Next, the debug target validates the signed unlock payload with the preloaded public key of the authentication server. Next, the debug target unlocks the at least one processing unit with an unlock vector from the validated unlock payload. After unlocking the at least one processing unit with the unlock vector, the debug target performs debug operations on the at least one processing unit.

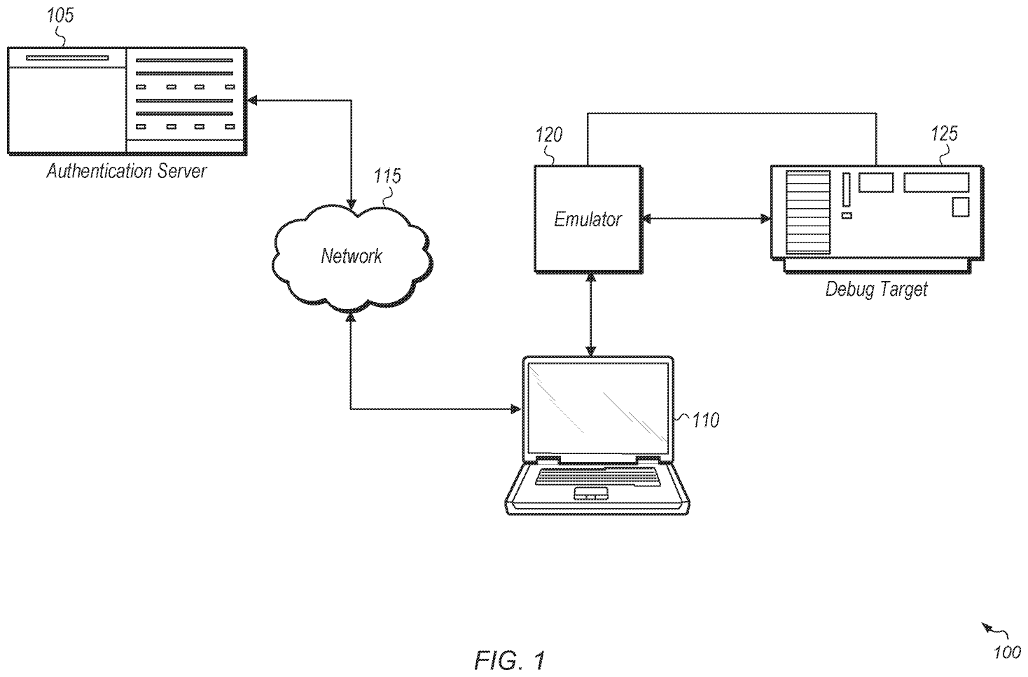

Referring now to FIG. 1, a block diagram of one implementation of a system 100 for preloading authorization payloads and keys on a computing module 110 and a debug target 125 to support future debug operations is shown. System 100 is intended to represent a system prior to computing module 110 and debug target 125 being installed inside a secure data center. In one implementation, the computing module 110 communicates with debug target 125 via emulator 120. In one implementation, computing module 110 and emulator 120 communicate over a network using a Secure Sockets Layer (SSL) connection. In one implementation, emulator 120 is a joint test action group (JTAG) emulator.

In one implementation, in order to perform debug operations on one or more processing units on debug target 125, the one or more processing units need to be unlocked using one or more unlock vectors. These unlock vectors are obtained and validated prior to computing module 110 and debug target 125 being located inside a secure data center. Computing module 110 is representative of any type of computing device (e.g., desktop computer, laptop computer, server, mobile device). In various implementations, computing module 110 includes one or more processors, one or more memory devices, a display, one or more input/output (I/O) interfaces, and the like. The one or more memory devices store program instructions which are executable by the one or more processors to implement one or more software debug applications. It is noted that computing module 110 can also be referred to as a “debug tool”.

In one implementation, computing module 110 prefetches an authorization payload from authentication server 105 over network 115. The authorization payload is fetched ahead of time to enable a future debug session to be initiated (if needed) for debug target 125. It is noted that authentication server 105 can also be referred to herein as a “key distribution server” or a “key server”. Network 115 is representative of any type of network or combination of networks, including wireless connection, direct local area network (LAN), metropolitan area network (MAN), wide area network (WAN), an Intranet, the Internet, a cable network, a packet-switched network, a fiber-optic network, a router, storage area network, or other type of network. Examples of LANs include Ethernet networks, Fiber Distributed Data Interface (FDDI) networks, and token ring networks. In various implementations, network 115 includes remote direct memory access (RDMA) hardware and/or software, transmission control protocol/internet protocol (TCP/IP) hardware and/or software, router, repeaters, switches, grids, and/or other components.

In one implementation, prior to retrieving an authorization payload from authentication server 105, software executing on computing module 110 generates a public-private key pair. Then, computing module 110 conveys the public key from the public-private key pair to authentication server 105. In response to receiving the public key, authentication server 105 generates and signs a certificate which associates the public key with this particular computing module 110. Authentication server 105 then sends the signed certificate to computing module 110. Debug target 125 also stores a secure debug unlock public key for later use when computing module 110 and debug target 125 are inside of a secure data center.

Additionally, in one implementation, debug target 125 conveys a unique device ID to computing module 110. In order to generate a secure request for acquiring an unlock vector designated for this particular debug target 125, computing module 110 signs the device ID with the private key from the public-private key pair. Computing module 110 then sends the secure request to authentication server 105. Authentication server 105 verifies the signature on the request and generates a secure debug unlock authorization payload signed by a secure debug unlock private key. Next, authentication server 105 sends the signed secure debug unlock authorization payload to computing module 110. Then, computing module 110 stores the signed secure debug unlock authorization payload to be used for later debug operations when computing module 110 and debug target 125 are inside of a secure data center.

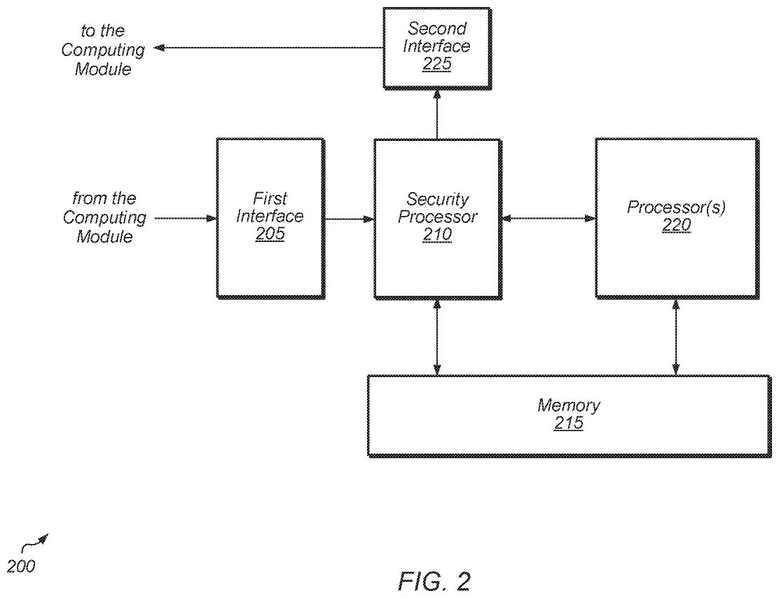

Turning now to FIG. 2, a block diagram of one implementation of a debug target 200 is shown. In one implementation, debug target 200 includes a first interface 205, security processor 210, memory 215, processor(s) 220, and second interface 225. In one implementation, first interface 205 is a joint test action group (JTAG) interface and second interface 225 is a universal serial bus (USB) interface. However, in other implementations, first interface 205 and second interface 225 can be other types of interfaces. Additionally, first interface 205 and second interface 225 are representative of any number of interfaces that are supported between a computing module (e.g., computing module 110 of FIG. 1) and debug target 200. It is noted that debug target 200 also includes any number of other components which are not shown to avoid obscuring the figure. Additionally, while security processor 210 is shown separate from processor(s) 220, in other implementations, security processor 210 can be included within one of the processor(s) 220 or within a system on chip (SoC) that includes processor(s) 220. In one implementation, debug target 200 is a system on chip (SoC). In this implementation, the components of debug target 200 are integrated together into a single integrated circuit (IC). In other implementations, debug target 200 is any of various other types of computing devices or computing systems.

In various implementations, security processor 210 manages the configuration and security of debug target 200. In one implementation, security processor 210 manages the boot-up process of debug target 200 to ensure that debug target 200 boots up with authenticated boot code. Security processor 210 also manages various other functions associated with the boot-up process of debug target 200. After the boot-up process and after performing any number of other functions, security processor 210 releases processor(s) 220 to execute the boot code and to launch the operating system of debug target 200. In various implementations, security processor 210 is preloaded with any number of public/private keys. As used herein, the term “security processor” is defined as an apparatus that executes instructions for performing authentication and validation functions which provide security protection for debug target 200. A main processor of processor(s) 220 is differentiated from security processor 210, with the main processor executing operating system instructions and user application instructions. An additional differentiating factor between a main processor and security processor 210 is that security processor 210 includes one or more security-related mechanisms (e.g., random number generator, cryptographic coprocessor). Also, security processor 210 stores one or more unique encryption/decryption keys inaccessible to the rest of debug target 200. Accordingly, security processor 210 provides a hardware-based root of trust for debug target 200, allowing debug target 200 to start up in a secure environment. It is noted that security processor 210 can also be referred to herein as a “secure coprocessor”.

Memory 215 is representative of any number and type of memory devices. In one implementation, memory 215 serves as the system memory for processor(s) 220. Processor(s) 220 are representative of any number of processing units that are included within debug target 200. For example, in one implementation, processor(s) 220 include a plurality of processor cores within a central processing unit (CPU). In one implementation, software is executed on processor(s) 220 as part of a debug test operation while debug target 200 is located inside of a secure data center. To enable the debug test operation to be performed inside of the secure data center, security processor 210 receives a preloaded secure debug authorization payload from a computing module (not shown). Security processor 210 validates the payload using a preloaded key and extracts an unlock vector from the payload for unlocking processor(s) 220 for the debug test operation.

After processor(s) 220 are unlocked, the computing module sends debug commands via the first interface 205 to security processor 210. Security processor 210 performs operations in response to receiving the debug commands and then sends commands and/or data to processor(s) 220 as a result of these operations. In some cases, security processor 210 writes instructions and/or data to memory 215, and processor(s) 220 retrieve the instructions from memory 215 for execution. In one implementation, security processor 210 retrieves data (generated by processor(s) 220 during one or more debug tests) from memory 215 and sends the data over second interface 225 to the computing module (e.g., debug tool). Second interface 225 is representative of any type of interface that is used for sending data back to the computing module.

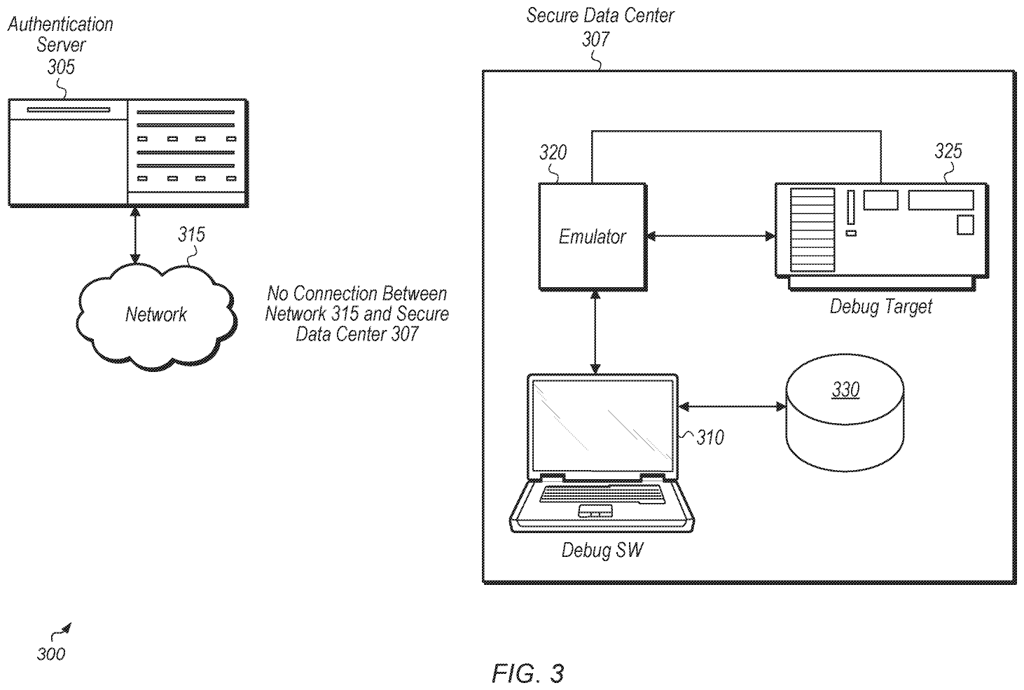

Referring now to FIG. 3, a block diagram of one implementation of a system 300 for performing debug operations within a secure data center 307 is shown. System 300 is intended to represent elements included in system 100 (of FIG. 1) at a later point in time after computing module 310 and debug target 325 have been installed inside a secure data center 307. As shown in FIG. 3, authentication server 305 and network 315 do not have a connection to the secure data center 307. Once inside the secure data center 307, the computing module 310 and debug target 325 perform operations to unlock one or more processors on debug target 325. In one implementation, the unlock operations use the preloaded authorization payload(s) and preloaded public/private key(s). After unlocking the one or more processors, computing module 310 executes debug software (SW) (i.e., a debug tool) and communicates with emulator 320 to run debug tests on the one or more processors of debug target 325.

In one implementation, in response to detecting a request to perform debug operations, computing module 310 retrieves a preloaded authorization payload from database 330 and delivers the preloaded authorization payload to debug target 325. Debug target 325 retrieves a preloaded key to validate the preloaded authorization payload to ensure that its unlock vector is not altered. Then, debug target 325 extracts the unlock vector from the authorization payload. In one implementation, after debug target 325 extracts the unlock payload from the authorization payload, debug target 325 uses the unlock payload to unlock a debug feature on one or more processing units. Then, computing module 310 is able to run one or more debug tests on the unlocked processing unit(s).

In one implementation, computing module 310 performs debug test(s) by executing debug software to create JTAG patterns. After creating the JTAG patterns, computing module 310 sends the JTAG patterns to the emulator 320. In response to receiving the JTAG patterns, the emulator 320 delivers corresponding JTAG commands to debug target 325. Debug target 325 outputs JTAG data shift outs which are conveyed through the emulator 320 to the debug software executing on computing module 310. The debug software then converts the JTAG data shift outs into debug data. In one implementation, the debug data is displayed on a debug software graphical user interface (GUI) to a user to help the user in resolving various issues during the debug process. In other implementations, other techniques for performing debug operations on debug target 325 are possible and are contemplated.

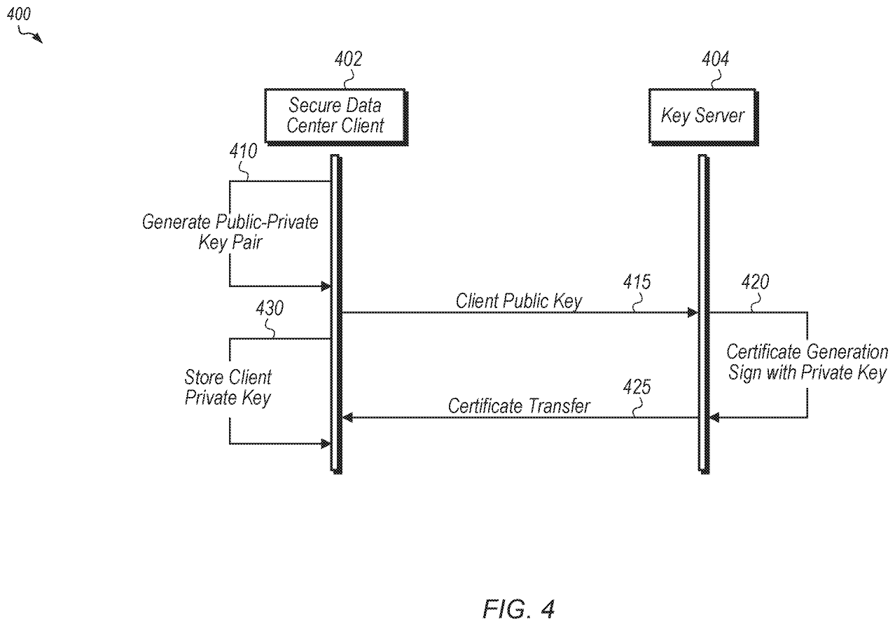

Turning now to FIG. 4, a diagram of one implementation of a pre-request sequence 400 for key and certificate generation prior to deployment into a secure data center is shown. A secure data center client 402 generates a public-private key pair (e.g., Rivest-Shamir-Adleman (RSA) public-private key pair) in step 410. Then, the data center public key and a uniquely assigned vendor ID of a processing unit on a debug target of secure data center client 402 is sent to the key server 404 in step 415. It is noted that key server 404 can also be referred to herein as an “authentication server”. The key server 404 generates a certificate (e.g., x.509 certificate) which ties the public key to this particular data center client 402 and key server 404 signs the certificate with a secure debug unlock key in step 420. The secure debug unlock key is used to communicate unlock vector payloads between a secure processor and a key server in normal debug scenarios (i.e., with external connections available). Next, the key server 404 sends the certificate to the data center client 402 in step 425. A private key is stored by the data center client 402 in step 430. In one implementation, the private key and a secure debug unlock public key are embedded into the basic input/output system (BIOS) image of a secure processor of the debug target of secure data center client 402.

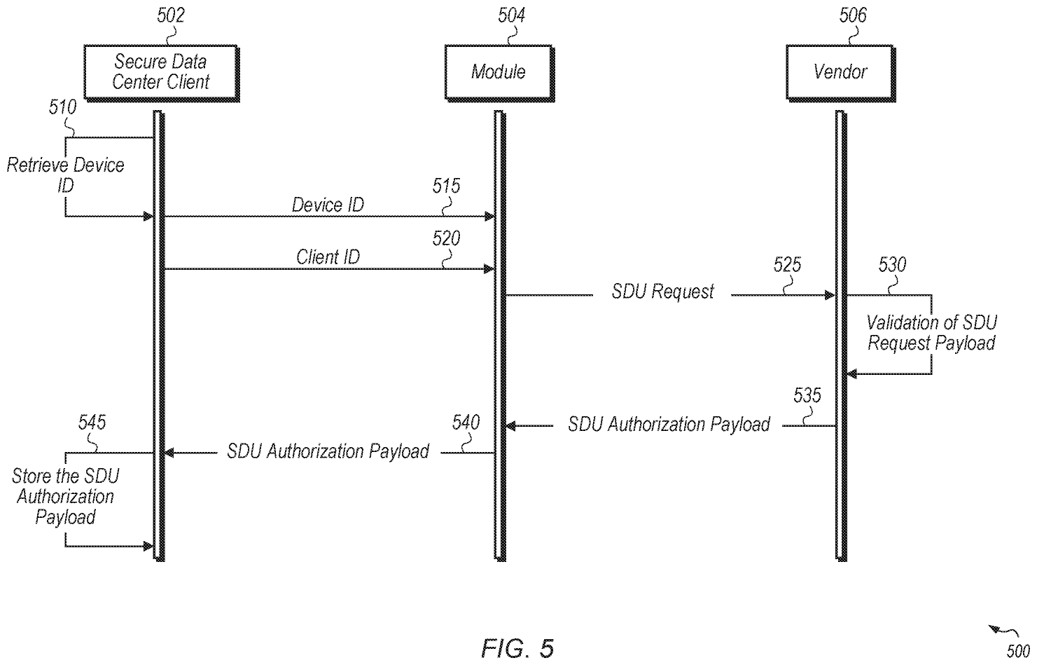

Referring now to FIG. 5, a diagram of one implementation of a pre-request sequence 500 performed prior to deployment in a secure data center is shown. In step 510, the secure data center client 502 retrieves a device ID from a debug target. In one implementation, the debug target is a system on chip (SoC), and step 510 is performed by scanning a bar code on the SoC. In other implementations, other ways of retrieving the device ID in step 510 can be utilized. In step 515, the secure data center client 502 sends the device ID to the computing module responsible for executing debug software. In one implementation, the computing module is a hardware debug tool such as a computing device (e.g., personal computer (PC), laptop) running a software debug application. Generally speaking, the computing module includes any suitable combination of hardware and/or software. In step 520, the data center client 502 sends a client ID which uniquely identifies the client to the computing module 504. It is noted that steps 515 and 520 can be performed concurrently.

In step 525, the computing module 504 sends a secure debug unlock (SDU) request to the vendor 506. In one implementation, the device ID and/or client ID is mapped and converted to a unique ID which is unique for the SoC. The computing module 504 generates a SDU request by signing the unique ID with the secure data center client private key to acquire the unlock vectors designated for this specific secure data center client 502. The vendor 506 is representative of the manufacturer or seller of the debug target device. It is noted that vendor 506 can also be referred to as a “key server” or “authentication server” herein. In one implementation, the payload format of the SDU request is: ID|VendorID|Sign (ID|VendorID). The ID refers to a unique device ID generated based on the device ID retrieved by the secure data center client in step 510. In one implementation, the debug target of secure data center client 502 is a system on chip (SoC). In other implementations, the debug target can be any of various other types of components. In one implementation, a two-dimensional bar code affixed to the SoC package is scanned and then mapped and converted to an ID which is unique for the SoC.

The vendor 506 verifies the signature on the request and generates a SDU authorization payload in step 530. Then, the vendor 506 signs the SDU authorization payload with the secure debug unlock key of the vendor 506. The signed SDU authorization payload is sent to the computing module 504 in step 535. In one implementation, the SDU authorization payload format is: Unlock_Vector|Device ID|VendorID|Sign (Unlock_Vector|Device ID|VendorID). The computing module 504 forwards the SDU authorization payload to the secure data center client 502 in step 540. The SDU authorization payload is saved and stored by the secure data center client 502 in step 545. The saved SDU authorization payload can then be used for later secure debug unlock usage, if needed. In one implementation, the SDU authorization payload is stored in a database by the secure data center client 502.

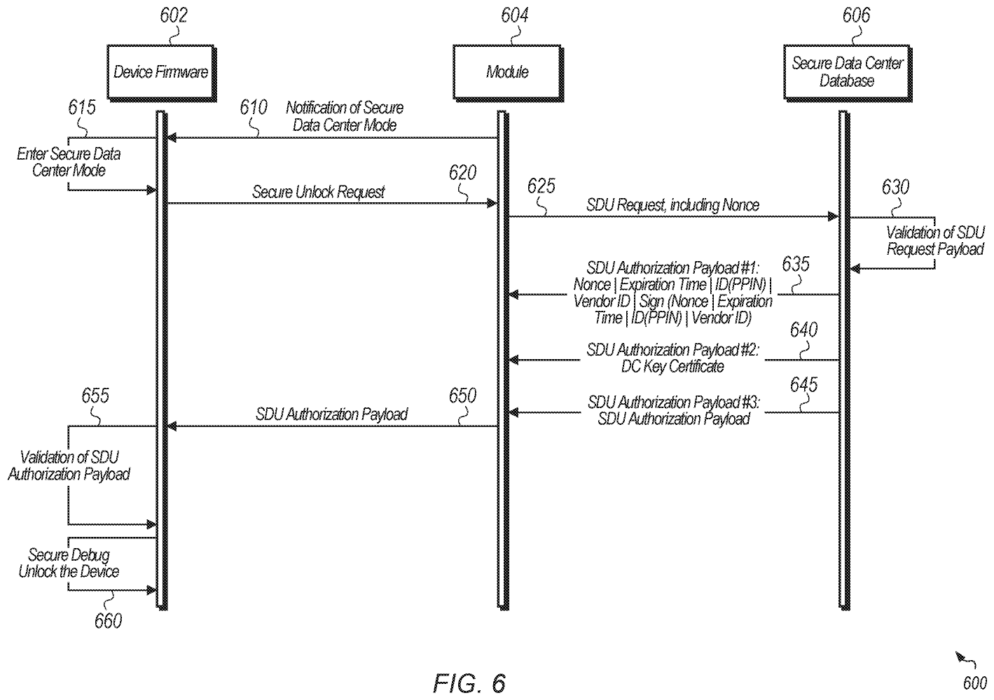

Turning now to FIG. 6, a diagram of one implementation of a sequence 600 for actual use of a preloaded secure debug unlock authorization payload inside a secure data center is shown. At step 610, the computing module 604 sends a notification of a request to enter secure data center mode to device firmware 602. In one implementation, device firmware 602 executes on a secure processor on the debug target. In response to receiving the notification, the device firmware 602 enters secure data center mode in step 615. Then, the device firmware 602 sends a secure debug unlock request to the computing module 604 in step 620. In one implementation, the secure debug unlock request includes a nonce generated by the device firmware 602. The nonce is a randomly generated number that is used a single time. The computing module 604 accesses the secure data center database 606 in step 625 to retrieve a previously obtained secure client public key in order to validate the secure debug unlock request payload.

In step 630, the secure debug unlock request payload is validated with a secure client public key stored in secure data center database 606. Also, the nonce is signed with an expiration time in step 630. If the secure debug unlock request payload is validated, then one or more previously obtained secure debug unlock authorization payloads are retrieved from secure data center database 606 in steps 635, 640, and 645. In one implementation, three secure debug unlock authorization payloads are retrieved by computing module 604. For example, in one implementation, the SDU authorization payload retrieved by computing module 604 in step 635 from the secure data center database 606 includes a first payload of the following format: Nonce|Expiration_Time|DeviceID_VendorID|Sign (Nonce|Expiration_Time|DeviceID|VendorID). In one implementation, the secure debug unlock authorization payload retrieved by computing module 604 in step 640 from the secure data center database 606 includes a second payload with a data center client key certificate from the vendor. In one implementation, the secure debug unlock authorization payload retrieved by computing module 604 in step 645 from the secure data center database 606 includes a third payload of the following format: Unlock_Vector|DeviceID|VendorID|Sign (Unlock_Vector|DeviceID|VendorID).

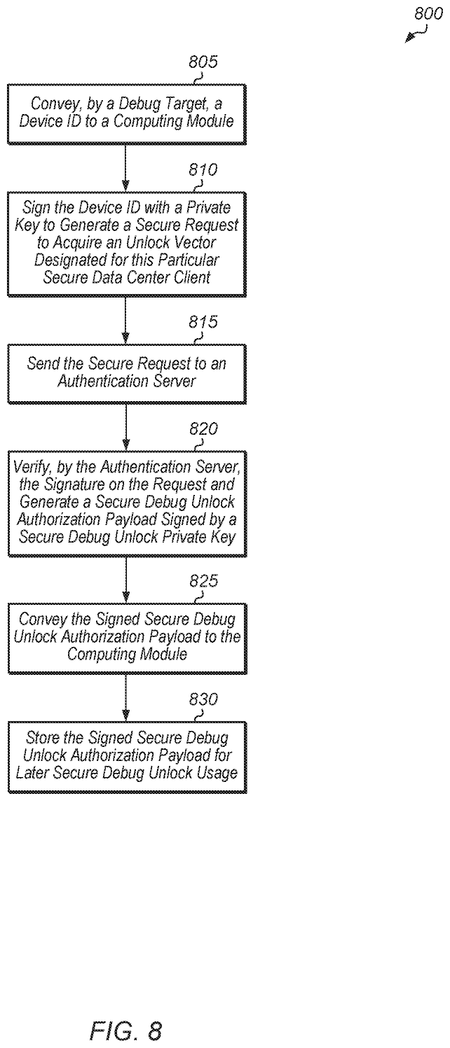

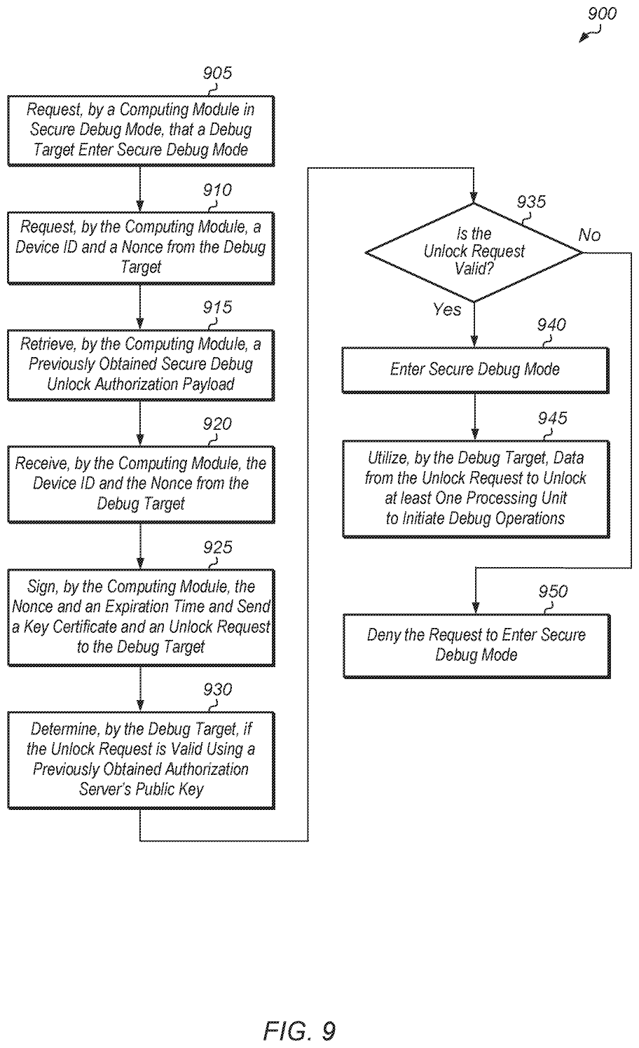

In step 650, the computing module 604 forwards the one or more authorization payload(s) to the device firmware 602. In step 655, the device firmware 602 validates the secure debug unlock authorization payload using a previously obtained public key. If the secure debug unlock authorization payload is validated, then in step 660, the device firmware 602 uses an unlock vector from the payload to unlock the debug target (e.g., SoC) for debug operations. implementing a prefetch operation of a secure data center mode dataset for future debug operations is shown. For purposes of discussion, the steps in this implementation and those of FIG. 8-9 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 700.

A computing module generates a public-private key pair (block 705). In one implementation, the computing module is maintained and operated by a secure data center client. The computing module delivers the public key from the public-private key pair to an authentication server (block 710). In one implementation, the authentication server is associated with a vendor that makes or sells a processing unit of a debug target coupled to the computing module. The authentication server generates and signs a certificate which ties the client's public key to this particular computing module (block 715). Next, the authentication server sends the signed certificate to the computing module (block 720). Also, the authentication server sends a secure debug unlock public key to the computing module (block 725). Next, the secure debug unlock public key is stored in a non-volatile memory device of a debug target for later use with subsequent secure debug sessions (block 730). After block 730, method 700 ends. It is noted that method 700 is performed prior to the computing module and debug target being installed inside a secure data center.

Turning now to FIG. 8, one implementation of a method 800 for performing a pre-request sequence for populating a secure data center database is shown. A debug target conveys a device identifier (ID) to a computing module (block 805). In one implementation, the device ID is a bar code or an ID derived from a root key which is unique for a processing unit (e.g., SoC, ASIC) on the debug target. In response to receiving the device ID, the computing module signs the device ID with a private key to generate a secure request to acquire an unlock vector designated for this secure data center client (block 810). The computing module sends the secure request to an authentication server (block 815). The authentication server verifies the signature on the secure request and generates a secure debug unlock authorization payload signed by a secure debug unlock private key (block 820). The authentication server conveys the signed secure debug unlock authorization payload to the computing module (block 825). The computing module stores the signed secure debug unlock authorization payload for later secure debug unlock usage (block 830). After block 830, method 800 ends. It is noted that method 800 is performed prior to the computing module and debug target being installed inside a secure data center.

Referring now to FIG. 9, one implementation of a method 900 for performing debug operations in secure data center debug mode is shown. A computing module (e.g., computer, laptop, mobile device, server) in secure debug mode requests that a debug target enter secure debug mode (block 905). It is noted that one type of secure debug mode is secure data center debug mode. The computing module also requests a device ID and a nonce from the debug target (block 910). Also, the computing module retrieves a previously obtained secure debug unlock authorization payload (block 915). It should be understood that the term “previously obtained” is defined as obtained prior to the computing module being operated inside of a secure installation (e.g., a secure data center). The computing module receives the device ID and the nonce from the debug target (block 920). Next, the computing module signs the nonce and an expiration time and sends a key certificate and an unlock request to the debug target (block 925). In one implementation, the unlock request includes the previously obtained secure debug unlock authorization payload.

Then, the debug target determines if the unlock request is valid using a previously obtained authorization server's public key (block 930). If the debug target determines that the unlock request is valid (conditional block 935, “yes” leg), then the debug target enters secure debug mode (block 940). While in secure debug mode, the debug target utilizes data (e.g., an unlock vector) from the unlock request to unlock at least one processing unit to initiate debug operations (block 945). Otherwise, if the debug target determines that the unlock request is invalid (conditional block 935, “no” leg), then the debug target denies the request to enter secure debug mode (block 950). After blocks 945 and 950, method 900 ends.

In various implementations, program instructions of a software application are used to implement the methods and/or mechanisms described herein. For example, program instructions executable by a general or special purpose processor are contemplated. In various implementations, such program instructions can be represented by a high level programming language, other implementations, the program instructions can be compiled from a high level programming language to a binary, intermediate, or other form. Alternatively, program instructions can be written that describe the behavior or design of hardware. Such program instructions can be represented by a high-level programming language, such as C. Alternatively, a hardware design language (HDL) such as Verilog can be used. In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a debug target comprising at least one processing unit; and
a computing module configured to convey a secure debug mode request and an unlock request to the debug target;
wherein the debug target is configured to:
receive the secure debug mode request and the unlock request; and
in response to validating the unlock request with a previously obtained public key of an authentication server:
enter secure debug mode;
unlock the at least one processing unit with data received in the unlock request; and
perform debug operations on the at least one processing unit.

2. The system as recited in claim 1, wherein prior to the secure debug mode request being conveyed from the computing module to the debug target, a preloaded signed unlock payload is stored in a memory device coupled to the computing module.

3. The system as recited in claim 1, wherein the public key of the authentication server was obtained prior to the debug target being located in a secure installation.

4. The system as recited in claim 1, wherein the unlock request comprises a payload which was previously signed by a private key of the authentication server.

5. The system as recited in claim 1, wherein the debug target is configured to operate in multiple different debug modes depending on a configuration of the system.

6. The system as recited in claim 1, wherein the debug target comprises a security processor configured to validate a preloaded signed unlock payload and unlock the at least one processing unit with an unlock vector from the preloaded signed unlock payload.

7. The system as recited in claim 1, wherein the computing module and the debug target are located inside of a secure installation and are not able to connect to devices outside of the secure installation.

8. A method comprising:
conveying, by a computing module, a secure debug mode request and an unlock request to a debug target comprising at least one processing unit;
receiving, by the debug target, the secure debug mode request and the unlock request; and
in response to validating the unlock request with a previously obtained public key of an authentication server, the debug target:
entering secure debug mode;
unlocking the at least one processing unit with data received in the unlock request; and
performing debug operations on the at least one processing unit.

9. The method as recited in claim 8, wherein prior to the secure debug mode request being conveyed from the computing module to the debug target, a preloaded signed unlock payload is stored in a memory device coupled to the computing module.

10. The method as recited in claim 8, wherein the public key of the authentication server was obtained prior to the debug target being installed in a secure installation.

11. The method as recited in claim 8, wherein the unlock request comprises a payload which was previously signed by a private key of the authentication server.

12. The method as recited in claim 8, wherein the debug target operates in multiple different debug modes depending on a configuration of an installation.

13. The method as recited in claim 8, further comprising validating, by a security processor of the debug target, a preloaded signed unlock payload and unlocking, by the security processor, the at least one processing unit with an unlock vector from the preloaded signed unlock payload.

14. The method as recited in claim 8, wherein the computing module and debug target are located inside of a secure installation and are not able to connect to devices outside of the secure installation.

15. An apparatus comprising:
at least one processor; and
a security processor;
wherein the security processor is configured to:
receive a request to enter a secure debug mode and an unlock request; and
in response to validating the unlock request with a previously obtained public key of an authentication server:
enter secure debug mode;
unlock the at least one processing unit with data received in the unlock request; and
perform debug operations on the at least one processing unit.

16. The apparatus as recited in claim 15, wherein prior to the request to enter secure debug mode being received, a preloaded signed unlock payload is stored on a memory device inside of a secure data center.

17. The apparatus as recited in claim 15, wherein the public key of the authentication server was obtained prior to the apparatus being located in a secure installation.

18. The apparatus as recited in claim 15, wherein the unlock request comprises a payload which was previously signed by a private key of the authentication server.

19. The apparatus as recited in claim 15, wherein the security processor is configured to operate in multiple different debug modes depending on a configuration of the apparatus.

20. The apparatus as recited in claim 15, wherein the security processor is located inside of a secure installation and is not able to connect to devices outside of the secure installation.
